(19) United States
(12) Patent Application Publication
(10) Pub. No.: US 2020/0286407 A1
(43) Pub. Date: Sep. 10, 2020

(54) Selectively Visible Product Marking System

(71) Applicant: Fran Lanciaux, Grand Rapid, OH (US)

(72) Inventor: Fran Lanciaux, Grand Rapid, OH (US)

(21) Appl. No.: 16/811,652

(22) Filed: Mar. 6, 2020

Related U.S. Application Data
(60) Provisional application No. 62/815,668, filed on Mar. 8, 2019.

(51) Int. Cl. G09F 3/00; C09D 11/50; B41M 3/14

(52) U.S. Cl. CPC G09F 3/0294; B41M 3/144; C09D 11/50

(57) ABSTRACT

A system for marking products to indicate compliance with the requirements of various agencies and organizations such as UL. Markings are applied to products with indicia that is selectively visible. The indicia may be formed with an ink that is visible only outside of the visible light spectrum. The markings can be discerned at any time by rendering the markings visible. Visibility may be achieved by exposing the marking to ultraviolet light, for example. When the light is extinguished, the markings are no longer perceptible.

### FIELD OF THE INVENTION

This invention is directed to a system for displaying desired and/or required product markings without diminishing or detracting from the appearance of the product.

### BACKGROUND OF THE INVENTION

Sometimes, it is necessary to mark products with informational or certification markings. As one non-limiting example, Underwriters Laboratories has very specific marking requirements for various products which, first, must meet UL's strict standards. In many instances, however, the required markings can detract significantly from the appearance of the marked products.

Accordingly, there is a need for a marking system which complies with various requirements for marking products without making the products themselves unnecessarily unsightly.

### SUMMARY OF THE INVENTION

The instant invention provides a system with which one may mark products to indicate compliance with the requirements of various agencies and organizations such as UL. According to the invention, markings are applied to products with indicia that is selectively visible. One example is indicia formed with an ink that is visible only outside of the visible light spectrum. Various agencies and certifying bodies, for example, can discern the markings at any time by rendering the markings visible. Visibility can be achieved, for example, by exposing the marking to ultraviolet light so that one may perceive the marking. When the light is extinguished, the markings are no longer perceptible. Thus, the system affords an agency or certifying body the ability to confirm that products are properly marked and, once this has been confirmed, the UV light, in this example, is extinguished and one who encounters the marked product will not perceive the markings on the marked product.

Accordingly, it is an object of the invention to provide a product marking system in which products are marked with indicia which is selectively visible. For example, an ink that is not visible to the human eye under the standard visible light spectrum, can be made visible for inspection and product approval purposes by employing plug-in or portable lighting sources that renders the product labeling perceptible.

It is another object of the invention to provide a product marking system that allows persons, such as for example, building inspectors to selectively render visible markings on components of an HVAC system, for example, to confirm that the product markings comply with an agency's requirements for component approvals and markings so that one who views those components, when they are not being inspected, does not perceive the markings.

It is a still further object of the invention to provide a marking system which meets various requirements for labeling and marking products yet does so in a way that the appearance of the product when in use is pleasing and uncluttered with information that is not needed by those who are not involved in inspecting or certifying the products.

These and other objects of the invention will be apparent from the following description of non-limiting examples of the invention.

### BRIEF DESCRIPTION OF THE DRAWING FIGURES

FIG. 1 is a perspective view of a section of an HVAC duct with a seam covered by a selectively visible product marking system.

FIG. 2 is a perspective view of the HVAC duct section shown in FIG. 1 where markings on the selectively visible product marking system have been selectively rendered visible.

### DETAILED DESCRIPTION OF PREFERRED EMBODIMENTS OF THE INVENTION

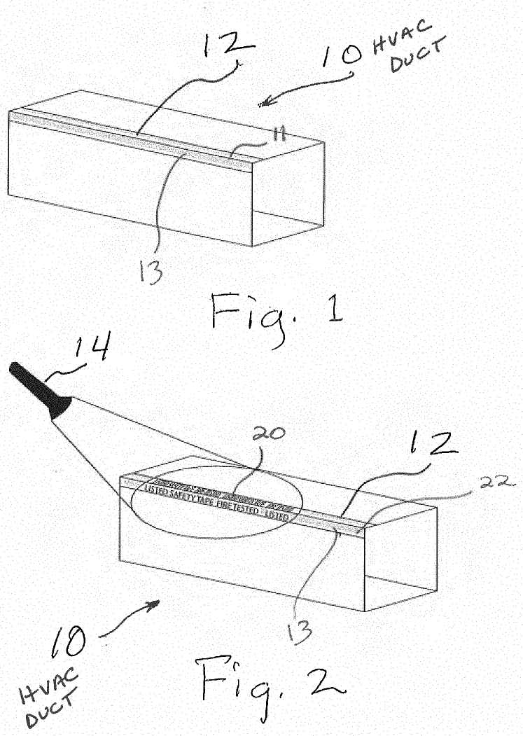

A section of an HVAC duct, indicated generally at 10 in FIGS. 1 and 2, has a longitudinal seam 11 that is covered by a flexible and selectively visible product marking system (hereafter “marking system”) 12. In HVAC parlance, the marking system 12 constitutes an HVAC duct closure and it is subject to marking/labelling requirements. Underwriters Laboratories has promulgated marking requirements for duct closures. The UL requirements provide that HVAC duct closures, such as tape or laminates used to seal ducts, must include a visible certification marking on every six square inches of the surface. Inspectors look for these markings and they must be visible in order to pass or approve a system after it's installed. However, such markings can be unsightly, and they only need to be seen by inspectors.

According to the marking system of the invention, certification marks, for example, are printed on and/or applied to the duct closure component of an HVAC installation. This is typically done before the components are assembled. The UL marking requirements are stringent. For example, UL181A governs the markings that must be applied to HVAC duct closure tape on Class 1 ductwork. UL181A requires that closure tape have a separate certification mark on every six square inches of exposed area. According to the invention, the certification mark and/or other required indicia is applied to the duct closure with an ink that is selectively visible and not discernable except outside of the visible spectrum of light. Examples of such inks include ultra-violet ink and infrared ink. Suitable inks may be those containing silver nitrate because they are selectively visible, and they do not suffer from sensitivity to heat. When exposed to a suitable light source such as an ultra-violet light source, inks containing silver nitrate are visible, and they are not discernable when the ultra-violet light source is removed.

In FIG. 1, the marking system 12 includes a base material 13 and indicia 20 formed on the base material 13. In the illustrated embodiment, the base material 13 is formed from HVAC compatible duct closure components, such as the non-limiting example of an adhesive backed, woven fabric, to provide strength. The threads or fill yarn of the fabric may be cotton, polyester, nylon, rayon or fiberglass. The fabric is a very thin gauze called “scrim” which is laminated to a backing of low-density polyethylene. However, in other embodiments, the base material 13 can be formed from other suitable materials. A visible top surface 22 of the base material 13 is printed with a selectively visible indicia 20. In FIG. 1, the selectively visible indicia 20 is not visible under the visible light spectrum. A light source 14 in FIG. 2 is shining on the marking system 12 with the result that the indicia 20 on the marking system, shown in FIG. 2, is visible.

Foils that can be applied to duct closures are well suited for the marking system of the invention. These materials must be marked with a suitable ink that is at least selectively visible. Inks, such as those described above, are selectively visible so that they serve the required marking function and do not degrade the aesthetics of the marked product. If desired, a poly coating may be overlaid on the printed foil to provide better performance and to prevent the ink from being disturbed.

While the marking system illustrated in FIGS. 1 and 2 is described above in the context of a duct closure component, it should be appreciated that the marking system can be used in other circumstances requiring selective viewing of markings. Non-limiting examples of other suitable uses of the marking system include emergency applications, medical applications, industrial machinery applications and the like.

It will be appreciated that the foregoing description of an example of the invention is provided only to enable one skilled in the art to practice and carry out the invention and should in no way be considered to be limiting so far as the scope of the invention is concerned.

I claim:

1. A selectively visible product marking system comprising:
an adhesive backed base material; and
a plurality of spaced apart indicia;
wherein the spaced apart indicia is selectively visible.

2. The selectively visible product marking system of claim 1, wherein the selectively visible product marking system is formed as an HVAC duct closure.

3. The selectively visible product marking system of claim 1, wherein the spaced apart indicia is formed by ink.

4. The selectively visible product marking system of claim 1, wherein the indicia is formed by printed foil.

5. The selectively visible product marking system of claim 1, wherein the selectively visible indicia is visible under ultra-violet light.

6. A method for complying with HVAC product marking requirements, the method comprising the steps of
printing or otherwise affixing a plurality of spaced apart markings on a duct closure component, wherein the markings are is comprised of selectively visible ink which is not visible in the visible spectrum of light,
assembling an HVAC duct having a seam,
affixing the duct closure component to the duct to seal the seam,
rendering the markings visible by exposing it to light outside of the visible spectrum, and
rendering the markings invisible by extinguishing the light.

7. The method of claim 6, including the step forming the plurality of markings with ink.

8. The method of claim 6, including the step of forming the plurality of markings with printed foil.

9. The method of claim 6, wherein the selectively visible plurality of marks are visible under ultra-violet light.

10. A section of HVAC duct, the duct section comprising
a duct wall having a seam, and
a selectively visible product marking system applied to and effectively sealing the seam, the selectively visible product marking system having an adhesive backed base material and a plurality of spaced apart indicia;
wherein the spaced apart indicia has the form of a selectively visible medium which is not discernable to the naked eye in the visible light spectrum, and is discernable to the naked eye when exposed to light outside of the visible spectrum.

11. The section of HVAC duct of claim 10, wherein the indicia is formed by ink.

12. The section of HVAC duct of claim 10, wherein the indicia is formed by printed foil.

13. The section of HVAC duct of claim 10, wherein the selectively visible indicia is visible under ultra-violet light.
